(19) United States
(12) Patent Application Publication
(10) Pub. No.: US 2026/0009444 A1
(43) Pub. Date: Jan. 8, 2026

(54) NEGATIVE POISSON'S RATIO VIBRATION ABSORBING BASE AND MILLING DEVICE FOR MILLING THIN-WALLED PARTS

(71) Applicant: Shandong University, Jinan (CN)

(72) Inventors: Kai Guo, Jinan (CN); Yangyang Shi, Jinan (CN); Jie Sun, Jinan (CN); Chunlu Song, Jinan (CN); Musen Liu, Jinan (CN); Longtao Li, Jinan (CN)

(73) Assignee: Shandong University, Jinan (CN)

(21) Appl. No.: 19/325,453

(22) Filed: Sep. 10, 2025

(30) Foreign Application Priority Data
Jan. 22, 2025 (CN) 202510101766.7

(51) Int. Cl. F16F 7/12; B23C 9/00; F16F 7/01

(52) U.S. Cl. CPC F16F 7/12; B23C 9/00; F16F 7/01; F16F 2224/0208; F16F 2224/0258

(57) ABSTRACT

A negative Poisson's ratio vibration absorbing base and milling device for milling thin-walled parts are provided. The base comprises a bottom plate and a workpiece supporting plate. Vibration reducing units are provided between the bottom plate and the workpiece supporting plate. Each of the vibration reducing units comprises a negative Poisson's ratio structure. The negative Poisson's ratio structure is fixed on a first vertical plate. Top end of the first vertical plate is fixed to the workpiece supporting plate, and bottom end of the first vertical plate is fixed to the bottom plate. Both sides of the first vertical plate above the negative Poisson's ratio structure are provided with bending beams. One end of a bending beam of the bending beams is connected to the first vertical plate, and an other end of the bending beam is connected to the second vertical plate fixed on the bottom plate.

### CROSS-REFERENCE TO RELATED APPLICATION

This application claims priority to Chinese Patent Application No. 202510101766.7, filed on Jan. 22, 2025, which is hereby incorporated by reference in its entirety.

### TECHNICAL FIELD

The present disclosure relates to the technical field of machining equipment, specifically to a negative Poisson's ratio vibration absorbing base and milling device for milling thin-walled parts.

### BACKGROUND ART

The statements here only provide background related to the present disclosure and do not necessarily constitute prior art.

In the field of machining, thin-walled part is extremely sensitive to vibration during milling due to its inherent characteristics such as thin walls, light weight, and relatively low rigidity. The vibration generated during the milling process can cause a series of serious problems, greatly affecting the quality of the machined surface, resulting in a significant increase in surface roughness and the appearance of obvious vibration patterns. In severe cases, the vibration may even cause deformation or damage to the thin-walled part, making the machining accuracy unable to meet the requirements. Vibrations can additionally accelerate wear of the cutting tool and shorten the service life of the cutting tools. Frequent replacement of cutting tools not only increases costs of the cutting tools, but also reduces machining efficiency due to downtime and replacement of the cutting tools, thereby increasing overall machining costs.

Patent No. CN105935795B discloses an adjustable damping vibration reduction device and vibration reduction method during the milling process of thin-walled parts, including: a vibration reduction device, the vibration reduction device includes a sealed cavity, a top plate installed on the flat surface of the sealed cavity, a constraint layer is located on the outer layer of the sealed cavity, a damping layer is installed inside the constraint layer, a damping layer substrate is installed inside the damping layer, magnetorheological fluid is filled within the damping layer substrate, six permanent magnets are installed in the magnetorheological fluid, and coils are wound on the outside of the permanent magnets. The above device can reduce the vibration during the milling process of the thin-walled parts. However, the above device has a complex structure of magnetorheological fluid, permanent magnets, coils, and etc., and the processing and manufacturing costs are high. When the above device is used, the coils need to be energized, increasing energy consumption and processing costs.

### SUMMARY

Regarding the shortcomings of the prior art, the purpose of the present disclosure is to provide a negative Poisson's ratio vibration absorbing base and milling device for milling thin-walled parts, which ensures excellent vibration reduction performance of the vibration absorbing base, has a simple structure, is easy to process and manufacture, does not consume additional energy during use, and does not increase the processing cost of milling.

In order to achieve the above objectives, the present disclosure is implemented through the following technical solution.

In the first aspect, a negative Poisson's ratio vibration absorbing base for milling thin-walled parts is provided by embodiments of the present disclosure. The device includes a bottom plate and a workpiece supporting plate provided parallel to the bottom plate. Multiple vibration reducing units are provided between the bottom plate and the workpiece supporting plate. Each of the multiple vibration reducing units includes a negative Poisson's ratio structure, which is fixed on a first vertical plate. Top end of the first vertical plate is fixed to the workpiece supporting plate. Bottom end of the first vertical plate is fixed to the bottom plate. Bending beams are provided on both sides of the first vertical plate above the negative Poisson's ratio structure. One end of a bending beam of the bending beams is connected to the first vertical plate, and an other end of the bending beam is connected to a second vertical plate fixed on the bottom plate. Both the bending beams and the negative Poisson's ratio structure are made of shape memory alloy materials.

In some embodiments, a distance between the bottom plate and a connection position between the bending beam and the first vertical plate is greater than a distance between the bottom plate and a connection position between the bending beam and the second vertical plate.

In some embodiments, the bending beams are S-shaped beams.

In some embodiments, the bottom plate, the workpiece supporting plate, the first vertical plate, and the second vertical plate are also made of shape memory alloy materials.

Furthermore, the bottom plate, the workpiece supporting plate, the negative Poisson's ratio structure, the bending beams, the first vertical plate, and the second vertical plate are made of nickel titanium memory alloy materials.

In some embodiments, the negative Poisson's ratio vibration absorbing base for milling thin-walled parts constituted by the bottom plate, the workpiece supporting plate, the negative Poisson's ratio structure, the bending beams, the first vertical plate, and the second vertical plate is integrally formed by metal three-dimensional (3D) printing.

In some embodiments, multiple hollow channels are provided inside the workpiece supporting plate, and damping particles are provided inside each of the multiple hollow channels.

In some embodiments, the damping particles are steel balls.

In some embodiments, the negative Poisson's ratio structure adopts a four-pointed star-shaped structure.

In some embodiments, the bottom plate is provided with fixture fixing holes, and the bottom plate can be fixed to a workpiece fixture through the fixture fixing holes.

In the second aspect, a device for milling thin-walled parts is provided by embodiments of the present disclosure, the device is provided with the negative Poisson's ratio vibration absorbing base for milling thin-walled parts according to the first aspect.

The beneficial effects of the present disclosure are as follows.
1. In the vibration absorbing base of the present disclosure, multiple vibration reducing units are provided between the workpiece supporting plate and the bottom plate. Each of the vibration reducing units is composed of a negative Poisson's ratio structure and bending beams, both of which are made of shape memory alloys. When the workpiece supporting plate is subjected to downward vibration excitation, the bending beams can immediately respond and produce a negative stiffness effect. That is, when the downward displacement increases, it resists the non-linear reduction of deformation force and quickly absorbs vibration energy. And the negative Poisson's ratio structure outputs a positive stiffness recovery force proportional to the displacement under compression. The positive and negative stiffness complement each other, promoting the entire base to reach a zero-stiffness state, strongly reducing vibration transmission, and effectively ensuring the machining accuracy and surface quality during milling the thin-walledparts. The entire base consists of the workpiece supporting plate, the bottom plate, and multiple vibration reducing units provided between the workpiece supporting plate and the bottom plate, without the need for setting up complex structures such as magnetorheological fluid, permanent magnets and coils. The present disclosure has a simple structure and low processing and manufacturing costs. By utilizing the structural performance of the base itself, vibration absorption can be achieved without the need of additional energy consumption and processing costs.
2. In the vibration absorbing base of the present disclosure, the entire base is made of 3D metal printing process, and the product has highly customized characteristics. For milling thin-walled parts with different materials, shapes, and sizes, it is convenient to adjust the size of the vibration reducing units, the parameters of the bending beams and the negative Poisson's ratio structures to achieve perfect adaptation between the vibration absorbing base and specific machining tasks. Whether it is complex thin-walled parts or components in the aerospace field or small thin-walled structural parts in precision instruments, the most suitable vibration absorbing base can be customized, greatly expanding the application range.

### BRIEF DESCRIPTION OF THE DRAWINGS

The accompanying drawings, which constitute a part of the present disclosure, are used to provide further understanding of the present disclosure. The illustrative embodiments and descriptions thereof are used to explain the present disclosure and do not constitute undue limitation of the present disclosure.

FIG. 1 is a schematic diagram of the overall structure of embodiment 1 of the present disclosure;

FIG. 2 is a front view of the overall structure of embodiment 1 of the present disclosure;

Reference numerals in figures: 1. workpiece supporting plate, 2. bottom plate, 3. negative Poisson's ratio structure, 4. bending beam, 5. first vertical plate, 6. second vertical plate, 7. hollow channel, 8. steel ball, 9. fixture fixing hole.

### DETAILED DESCRIPTION OF THE EMBODIMENTS

For the convenience of description, if the term “up” or “down” appear in the present disclosure, it only indicates that the directions indicated by the terms are consistent with the up and down directions of the drawings themselves, and does not limit the structure. It is only for the convenience of describing the present disclosure and simplifying the description, and does not indicate or imply that the device or component referred to must have a specific orientation, be constructed and operated in a specific orientation. Therefore, it cannot be understood as a limitation of the present disclosure.

### Embodiment 1

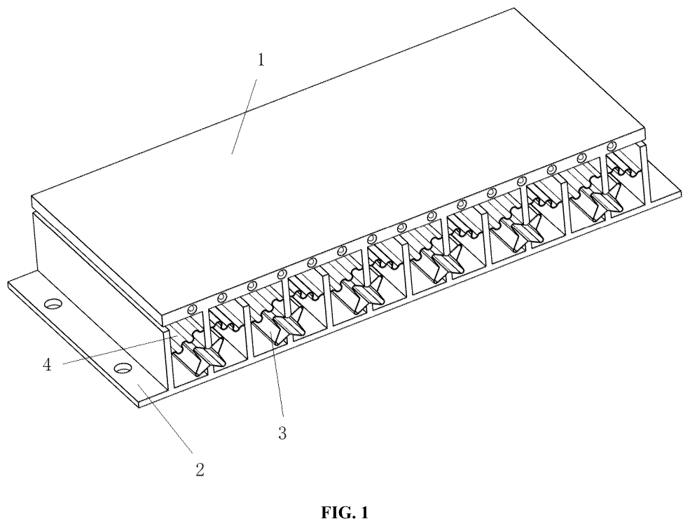

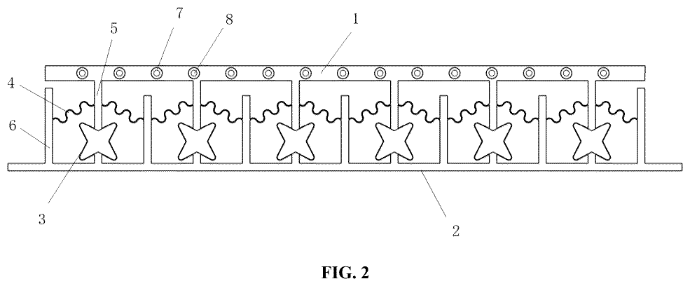

The embodiment provides a negative Poisson's ratio vibration absorbing base for milling thin-walled parts. As shown in FIGS. 1 to 2, the negative Poisson's ratio vibration absorbing base includes a bottom plate 2 and a workpiece supporting plate 1 provided parallel to the bottom plate 2. The workpiece supporting plate 1 is located above the bottom plate 2, and is used to support the thin-walled parts needed to be processed. The bottom plate 2 is fixed on the milling machine tool. Multiple vibration reducing units are provided between the workpiece supporting plate 1 and the bottom plate 2. The vibration reducing units are used to consume the vibration energy to achieve vibration reduction.

In the embodiment, the workpiece supporting plate 1 and the bottom plate 2 both adopt rectangular plates. In other embodiments, the workpiece supporting plate 1 and the bottom plate 2 both may adopt square plates, circular plates or other types of plates. Ordinary skilled in the art can choose according to actual needs.

The vibration reducing unit includes a negative Poisson's ratio structure 3, bending beams 4, a first vertical plate 5 and a second vertical plate 6.

The negative Poisson's ratio structure 3, the bending beams 4, the first vertical plate 5, the second vertical plate 6, the bottom plate 2, and the workpiece supporting plate 1 are all made of shape memory alloys. During the process, they are integrated formed by utilizing the metal 3D printing process.

The metal 3D printing process has a high processing accuracy, which is convenient for forming the complex structures. And the products produced by utilizing the metal 3D printing process have highly customized characteristics. For milling thin-walled parts with different materials, shapes, and sizes, it is convenient to adjust the size of the vibration reducing units, the parameters of the bending beams 4 and the negative Poisson's ratio structure 3 to achieve perfect adaptation between the vibration absorbing base and specific machining tasks. Whether it is complex thin-walled parts or components in the aerospace field or small thin-walled structural parts in precision instruments, the most suitable vibration absorbing base can be customized, greatly expanding the application range.

In some embodiments, the negative Poisson's ratio structure 3, the bending beams 4, the first vertical plates 5, the second vertical plates 6, the bottom plate 2, and the workpiece supporting plate 1 are all made of nickel titanium memory alloy materials. This not only expands the application boundaries of nickel titanium memory alloys in the field of vibration absorption, but also fully explores the potential properties of materials through 3D printing technology, injecting new vitality into the development of materials science and engineering, and promoting more high-performance and functional materials to play a key role in industrial manufacturing.

Top end of the first vertical plates 5 and the workpiece supporting plate 1 are vertically fixedly connected in an integrated manner. Bottom end of the first vertical plates 5 and the bottom plate 2 are vertically fixedly connected in an integrated manner. The negative Poisson's ratio structure is integrally provided above the first vertical plate.

In this embodiments, the negative Poisson's ratio structure 3 adopts a four-pointed star-shaped structure, including four branches. The first vertical plate 5 is connected to an inflection point of two opposite branches of the four branches. The negative Poisson's ratio structure divides the first vertical plate 5 into two parts, including a part above the negative Poisson's ratio structure 3 and a part below the negative Poisson's ratio structure 3. Top end of the part above the negative Poisson's ratio structure 3 is integrally connected to the workpiece supporting plate 1, and the bottom end of the part below the negative Poisson's ratio structure 3 is integrally connected to the bottom plate 2.

It is understandable that the negative Poisson's ratio structure 3 may also be negative Poisson's ratio structure in other shapes. Ordinary skilled in the art can set according to actual needs, and will not provide a detailed description here.

Bending beams 4 are provided at both sides of the first vertical plate above the negative Poisson's ratio structure 3. In this embodiment, the bending beams are S-shaped beams. One end of a bending beam 4 is integrally connected to the first vertical plate 5, and an other end of the bending beam 4 is integrally connected to the second vertical plate 6. Bottom end of the second vertical plate 6 is vertically integrally connected to the bottom plate 2.

In other embodiments, the bending beams 4 may also be wavy beams or other types of beams. Ordinary skilled in the art can choose according to actual requirements, and will not provide a detailed description here.

Furthermore, a distance between the bottom plate 2 and a connection position between the bending beam 4 and the first vertical plate 5 is greater than a distance between the bottom plate 2 and a connection position between the bending beam 4 and the second vertical plate 6.

In the vibration absorbing base of this embodiment, the workpiece supporting plate 1 is used to support the thin-walled parts needed to be processed. When the workpiece supporting plate 1 is subjected to downward pressure vibration excitation, the bending beam 4 responds immediately. Relying on shape and material properties of the bending beam 4, it generates a negative stiffness effect contrary to the conventional one. That is, when the downward pressure displacement increases, the nonlinear resistance to deformation force decreases, and the vibration energy is rapidly absorbed. Meanwhile, the negative Poisson's ratio structure 3 relies on its own microstructure, causes orderly deformation of the internal organization of the material under pressure, outputting a positive stiffness restoring force proportional to the displacement. The positive and negative stiffness complement each other, promoting the entire vibration absorbing base to achieve a quasi-zero stiffness state, effectively reducing vibration transmission, and truly ensuring the processing accuracy and surface quality of milling the thin-walled parts.

In order to further dissipate vibration energy and achieve vibration reduction, interior of the workpiece support plate 1 is provided with multiple hollow channels 7, which are parallel and distributed in an equal internal. The axis of the hollow channels 7 is parallel to the negative Poisson's ratio structure and the length direction of the bending beam. Interior of the hollow channels is provided with multiple damping particles. In this embodiment, the damping particles are steel balls 8.

When using metal 3D printing process, the both ends of the hollow channel 7 can only be open, in order to prevent damping particles from flowing out of the hollow channel 7. The both ends of the hollow channel 7 are provided with blocking parts to block the both ends of the hollow channel.

In this embodiment, the blocking parts are blocking bolts. Tapping is carried out at both ends of the hollow channel 7. Threads of the blocking bolts are connected at both ends of the hollow channel, thus achieving the blocking of the hollow channel.

When vibration occurs during the processing process, the vibration can be transmitted to damping particles, the damping particles collide with each other and further dissipate the energy generated by the vibration, playing a role in vibration reduction.

The length of the bottom plate 2 is greater than that of the workpiece supporting plate 1. Both sides of the bottom plate 2 located in the projection area of the workpiece supporting plate 1 are provided with fixture fixing holes. Preferably, each side of the both sides is provided with two fixture fixing holes. The bottom plate 2 can install fixtures through the fixture fixing holes. The fixtures are used to clamp thin-walled parts from both sides and play a positioning role for the thin-walled parts.

When the negative Poisson's ratio vibration absorbing base for milling thin-walled parts of this embodiment is adopted, the negative Poisson's ratio structure 3 is combined with the bending beams 4. The unique positive and negative stiffness characteristics of both the negative Poisson's ratio structure 3 and the bending beams 4 are utilized to accurately counteract vibration energy during the milling process of the thin-walled parts. When the milling cutting tool generates vibration and transmits it to the base, the negative stiffness of the bending beam 4 quickly absorbs energy, and the positive stiffness of the negative Poisson's ratio structure 3 provides a stable support. The bending beam 4 and the negative Poisson's ratio structure 3 work together to make the base reach a quasi-zero stiffness state. Compared with the base of traditional thin-walled parts milling machine tools, the base of this embodiment may significantly reduce the vibration amplitude, effectively reduce the vibration patterns on the machining surface of the thin-walled parts, significantly improve processing accuracy, and meet the needs of high-precision processing of the thin-walled parts.

Moreover, the vibration absorbing base of this embodiment is integrally formed by utilizing metal 3D printing process. Compared with the current vibration absorbing base that requires complex structures such as magnetorheological fluid, permanent magnets, coils, and etc., the structure of this embodiment is simpler and the processing and manufacturing are more convenient. It is made of nickel titanium memory alloy, which is lightweight. The workpiece supporting plate 1 adopts a flat plate, which is more convenient to cooperate with the thin-walled parts. The bottom plate 2 also adopts a flat plate, which is convenient to be directly fixed on the milling machine tool and lightweight. It will not have a negative impact on the dynamic characteristics of the thin-walled part processing system. It not only does not affect the original processing operation of the thin-walled parts, but also maximizes the vibration reduction effect and reduces interference to the overall performance of the processing system.

When the vibration absorbing base of this embodiment is used, own structure and material characteristics of which achieve vibration reduction function, without the need of additional electricity or other energy sources, reducing energy consumption and not increasing milling processing costs.

### Embodiment 2

This embodiment provides a device for milling thin-walled parts, which is provided with a negative Poisson's ratio vibration absorbing base for milling thin-walled parts as described in Embodiment 1. The bottom plate 2 is fixed on the worktable of the milling device, and fixtures are fixed on both sides of the bottom plate through fixture fixing holes. The remaining structures of the milling device may adopt existing technology and will not be described in detail here.

The above description is only preferred embodiments of the present disclosure and is not intended to limit the present disclosure. For those skilled in the art, the present disclosure may have various modifications and variations. Any modifications, equivalent substitutions, improvements, and etc. made within the spirit and principles of the present disclosure shall be included within the scope of protection of the present disclosure.

What is claimed is:

1. A negative Poisson's ratio vibration-absorbing base for milling thin-walled parts, comprising a bottom plate and a workpiece supporting plate provided parallel to the bottom plate,
wherein a plurality of vibration reducing units are provided between the bottom plate and the workpiece supporting plate, wherein each of the plurality of vibration reducing units comprises a negative Poisson's ratio structure and is fixed on a first vertical plate, wherein a top end of a first vertical plate is fixed to the workpiece supporting plate, and bottom end of the first vertical plate is fixed to the bottom plate, and wherein bending beams are provided on both sides of the first vertical plate above the negative Poisson's ratio structure, wherein one end of a bending beam of the bending beams is connected to the first vertical plate, and an other end of the bending beam is connected to a second vertical plate fixed on the bottom plate,
wherein the bending beams and the negative Poisson's ratio structure are made of shape memory alloy materials.

2. The negative Poisson's ratio vibration absorbing base for milling thin-walled parts according to claim 1, wherein a distance between the bottom plate and a connection position between the bending beam and the first vertical plate is greater than a distance between the bottom plate and a connection position between the bending beam and the second vertical plate.

3. The negative Poisson's ratio vibration absorbing base for milling thin-walled parts according to claim 1, wherein the bending beams are S-shaped beams.

4. The negative Poisson's ratio vibration absorbing base for milling thin-walled parts according to claim 1, wherein the bottom plate, the workpiece supporting plate, the first vertical plate, and the second vertical plate are also made of shape memory alloy materials;
and wherein the shape memory alloy materials are nickel titanium memory alloy materials.

5. The negative Poisson's ratio vibration absorbing base for milling thin-walled parts according to claim 4, wherein the negative Poisson's ratio vibration absorbing base for milling thin-walled parts constituted by the bottom plate, the workpiece supporting plate, the negative Poisson's ratio structure, the bending beams, the first vertical plate, and the second vertical plate is integrally formed by metal 3D printing.

6. The negative Poisson's ratio vibration absorbing base for milling thin-walled parts according to claim 1, wherein a plurality of hollow channels are provided inside the workpiece supporting plate, and damping particles are provided inside each of the plurality of hollow channels.

7. The negative Poisson's ratio vibration absorbing base for milling thin-walled parts according to claim 6, wherein the damping particles are steel balls.

8. The negative Poisson's ratio vibration absorbing base for milling thin-walled parts according to claim 1, wherein the negative Poisson's ratio structure adopts a four-pointed star-shaped structure.

9. The negative Poisson's ratio vibration absorbing base for milling thin-walled parts according to claim 1, wherein the bottom plate is provided with fixture fixing holes, and the bottom plate can be fixed to a workpiece fixture through the fixture fixing holes.

10. A device for milling thin-walled parts, provided with a negative Poisson's ratio vibration absorbing base for milling thin-walled parts, wherein the negative Poisson's ratio vibration absorbing base for milling thin-walled parts comprises:
a bottom plate and a workpiece supporting plate provided parallel to the bottom plate, wherein a plurality of vibration reducing units are provided between the bottom plate and the workpiece supporting plate, wherein each of the plurality of vibration reducing units comprises a negative Poisson's ratio structure and is fixed on a first vertical plate, wherein a top end of a first vertical plate is fixed to the workpiece supporting plate, and bottom end of the first vertical plate is fixed to the bottom plate, and wherein bending beams are provided on both sides of the first vertical plate above the negative Poisson's ratio structure, wherein one end of a bending beam of the bending beams is connected to the first vertical plate, and an other end of the bending beam is connected to a second vertical plate fixed on the bottom plate,
wherein the bending beams and the negative Poisson's ratio structure are made of shape memory alloy materials.

11. The device according to claim 10, wherein a distance between the bottom plate and a connection position between the bending beam and the first vertical plate is greater than a distance between the bottom plate and a connection position between the bending beam and the second vertical plate.

12. The device according to claim 10, wherein the bending beams are S-shaped beams.

13. The device according to claim 10, wherein the bottom plate, the workpiece supporting plate, the first vertical plate, and the second vertical plate are also made of shape memory alloy materials;
and wherein the shape memory alloy materials are nickel titanium memory alloy materials.

14. The device according to claim 13, wherein the negative Poisson's ratio vibration absorbing base for milling thin-walled parts constituted by the bottom plate, the workpiece supporting plate, the negative Poisson's ratio structure, the bending beams, the first vertical plate, and the second vertical plate is integrally formed by metal 3D printing.

15. The device according to claim 10, wherein a plurality of hollow channels are provided inside the workpiece supporting plate, and damping particles are provided inside each of the plurality of hollow channels.

16. The device according to claim 15, wherein the damping particles are steel balls.

17. The device according to claim 10, wherein the negative Poisson's ratio structure adopts a four-pointed star-shaped structure.

18. The device according to claim 10, wherein the bottom plate is provided with fixture fixing holes, and the bottom plate can be fixed to a workpiece fixture through the fixture fixing holes.
